(19) United States
(12) Patent Application Publication
(10) Pub. No.: US 2013/0317780 A1
(43) Pub. Date: Nov. 28, 2013

(54) PROBABILITY OF FAILURE ON DEMAND CALCULATION USING FAULT TREE APPROACH FOR SAFETY INTEGRITY LEVEL ANALYSIS

(71) Applicants: Yogesh Agarwal, Bangalore (IN); Charles Scott Sealing, Clifton, NY (US)

(72) Inventors: Yogesh Agarwal, Bangalore (IN); Charles Scott Sealing, Clifton, NY (US)

(73) Assignee: General Electric Company, Schenectady, NY (US)

(21) Appl. No.: 13/478,212

(22) Filed: May 23, 2012

(51) Int. Cl. G06F 19/00

(52) U.S. Cl. 702/181

(57) ABSTRACT

A computer-readable medium including computer-executable instructions that, when executed by a processor, cause the processor to perform acts, via an associated method that includes selecting a fault tree based upon an architecture of a safety instrumented system. The method includes evaluating at least a failure probability due to dangerous detected failures and a failure probability due to dangerous undetected failures as a function of values of factors. A portion of the failure probability due to dangerous undetected failures is based on failures detected during proof testing and a remainder of the failure probability due to dangerous undetected failures is based on failures detected during refurbishment. The method includes generating a probability of failure on demand for the safety instrumented system by combining at least the failure probability due to dangerous detected failures and the failure probability due to dangerous undetected failures according to the fault tree.

### BACKGROUND OF THE INVENTION

1. Field of the Invention

This application relates generally to safety and reliability quantification and, more specifically, to systems and methods that evaluate probability of failure on demand using a fault tree approach.

2. Description of Related Art

An industrial environment such as, for instance, a power generating plant typically includes one of more safety instrumented systems. A safety instrumented system typically includes a sensor, logic solver (e.g., controller), and final element (e.g., valve, actuator, etc.). A safety instrumented system can perform a safety critical function to achieve or maintain a safe state of a process when unacceptable or dangerous process conditions are detected. By way of example, one or more sensors included in the safety instrumented system can detect abnormal operating conditions. Upon detecting abnormal operating conditions, the one or more sensors can transmit input signal(s) to the logic solver. Further, the logic solver can receive the input signal(s) from the one or more sensors based on the detected abnormal operating conditions. The logic solver can modify output(s) as a function of the received input signal. The output(s) from the logic solver can be supplied to final element(s), thereby causing the final element(s) to transition to a safe state.

In one scenario, sensor(s) included in a safety instrumented system can monitor a flow rate through a valve. If the sensor(s) detect that the flow rate is higher than a threshold level, then the sensor(s) can supply input signal(s) to a logic solver included in the safety instrumented system. The logic solver can alter the output(s) yielded thereby based upon the received input signal(s) since the input signal(s) signify that the flow rate exceeds the threshold level. Thus, the output(s) supplied by the logic solver can cause the valve to close when the sensor(s) detect that the flow rate is higher than the threshold value, for instance.

Various standards have emerged to evaluate whether a safety instrumented system within an industrial environment will respond appropriately when acting during an emergency event. Examples of the standards include International Electrotechnical Commission (IEC) 61508 and 61511 standards. The standards specify Safety Integrity Levels (SILs). Typically, a safety critical function performed by a safety instrumented system is quantified in terms of a Safety Integrity Level (SIL), where the SIL is a relative level of risk reduction provided by the safety critical function. Within the IEC 61508 and 61511 standards, four discrete SILs are defined, with SIL 4 having the highest safety integrity and SIL 1 having the lowest safety integrity.

A SIL is conventionally assigned to a safety critical function based upon a probabilistic analysis of the safety critical function. For instance, a safety critical function can be allotted a given SIL based on a target maximum probability of dangerous failure of the safety critical function. Accordingly, probability of failure on demand (PFD) for a safety critical function is calculated and used to quantify the safety integrity of the safety critical function in terms of SIL. However, traditional approaches for calculating PFD oftentimes employ a Markov's analysis approach. These traditional approaches for determining PFD utilize complex simulations. Due to the complexity of the Markov's analysis approach, a PFD calculated employing the Markov's analysis approach may be unable to be verified. Further, insights concerning factors that contribute to the PFD typically are unable to be determined from conventional techniques that leverage the Markov's analysis approach due to the complexity.

### BRIEF SUMMARY OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a computer-readable medium including computer-executable instructions that, when executed by a processor, cause the processor to perform acts, via an associated method that includes selecting a fault tree based upon an architecture of a safety instrumented system. The method includes evaluating at least a failure probability due to dangerous detected failures and a failure probability due to dangerous undetected failures associated with the safety instrumented system as a function of values of factors. A portion of the failure probability due to dangerous undetected failures is based on failures detected during proof testing and a remainder of the failure probability due to dangerous undetected failures is based on failures detected during refurbishment. The method includes generating a probability of failure on demand (PFD) for the safety instrumented system by combining at least the failure probability due to dangerous detected failures and the failure probability due to dangerous undetected failures according to the fault tree.

In accordance with another aspect, the present invention provides a method that facilitates determining a probability of failure on demand (PFD) for a safety instrumented system configured for execution on a processor of a computing device. The method includes providing a fault tree selected to evaluate the safety instrumented system. The method includes evaluating failure probabilities at least due to dangerous detected failures and dangerous undetected failures associated with the safety instrumented system as a function of values of factors. The method includes combining the failure probabilities according to the fault tree to yield the PFD for the safety instrumented system.

### BRIEF DESCRIPTION OF THE DRAWINGS

The claimed subject matter may take physical form in certain parts and arrangement of parts, example embodiments of which will be described in detail in this specification and illustrated in the accompanying drawings which form a part hereof and wherein:

FIG. 1 illustrates an example system that evaluates a probability of failure on demand (PFD) for a safety instrumented system;

FIG. 2 illustrates another example system that calculates a PFD;

FIG. 3 illustrates an example system that yields a failure probability due to dangerous detected failures;

FIG. 4 illustrates an example system that yields a failure probability due to dangerous undetected failures;

FIG. 5 illustrates an example fault tree that can be utilized when generating a PFD for a 1oo1 architecture;

FIG. 6 illustrates an example fault tree that can be utilized when generating a PFD for a 1oo2 architecture;

FIG. 7 illustrates an example methodology that facilitates determining a probability of failure on demand (PFD) for a safety instrumented system; and

FIG. 8 illustrates an example computing device that can be used in accordance with the systems and methodologies disclosed herein.

### DETAILED DESCRIPTION OF THE INVENTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

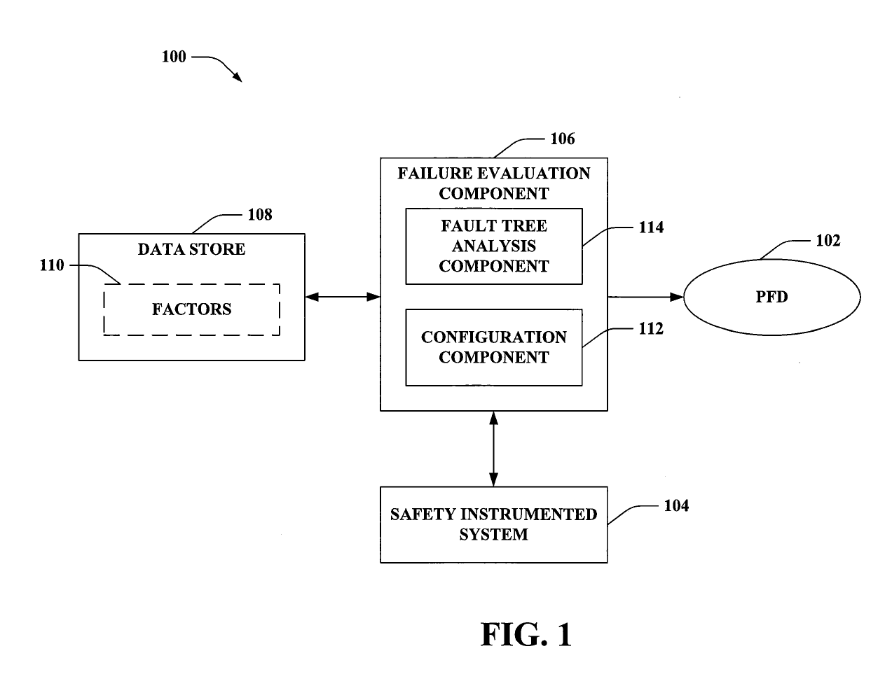

Referring now to the drawings, FIG. 1 illustrates a system 100 that evaluates a probability of failure on demand (PFD) 102 for a safety instrumented system 104. The system 100 includes a failure evaluation component 106 and a data store 108. The failure evaluation component 106 retrieves values of factors 110 retained in the data store 108 and calculates the PFD 102 based upon the values of the factors 110 that are retrieved from the data store 108. The PFD 102 calculated by the failure evaluation component 106 can be an average probability of failure on demand, PFD(Avg). According to an example, a SIL can be assigned to the safety instrumented system 104 as a function of the PFD 102 yielded by the failure evaluation component 106; however, it is to be appreciated that the claimed subject matter is not so limited.

The failure evaluation component 106 further includes a configuration component 112 and a fault tree analysis component 114. The configuration component 112 can provide a fault tree for use by the fault tree analysis component 114. For example, the fault tree provided by the configuration component 112 can be selected in response to an input (e.g., received from a user). According to another example, the configuration component 112 can identify an architecture of the safety instrumented system 104; following this example, the configuration component 112 can choose a fault tree associated with the identified architecture of the safety instrumented system 104.

Further, factors 110 retained in the data store 108 to be utilized as part of the evaluation by the fault tree analysis component 114 for evaluating the PFD 102 can be identified. The factors 110 can be identified based upon the fault tree utilized by the fault tree analysis component 114 (e.g., the identified factors 110 can vary depending on the fault tree). The fault tree analysis component 114 leverages the fault tree provided by the configuration component 112 to yield the PFD 102 for the safety instrumented system 104 based on the identified factors 110.

The safety instrumented system 104 can include one or more channels. An overall failure rate of a channel is a summation of a dangerous failure rate and a safe failure rate. Moreover, a dangerous failure rate can include a dangerous detected failure rate and a dangerous undetected failure rate. Hence, a failure rate of a channel can be divided into four different modes of failure: safe detected, safe undetected, dangerous detected, and dangerous undetected. When determining the PFD 102, dangerous detected and dangerous undetected failure modes are considered by the fault tree analysis component 114.

Dangerous detected failures are identified from diagnostic testing. A dangerous detected failure is a dangerous failure that can be detected by internal diagnostics which can cause an output signal to go to an alarm state. For instance, while a safety instrumented system is running, conditions of the channels can be monitored. Failures that are detected through such diagnostic testing are considered to be dangerous detected failures.

As opposed to being detected from diagnostic testing, dangerous undetected failures can be detected through proof testing. In contrast to diagnostic testing, which are automatically performed, a proof test commonly is performed manually and offline. According to an example, the evaluation effectuated by the fault tree analysis component 114 can contemplate that a proof test reveals a subset of the dangerous undetected failures, while a remainder of the dangerous undetected failures may not be revealed through proof testing; however, it is to be appreciated that the claimed subject matter is not so limited.

The architecture of the safety instrumented system 104 can specify the number of channels in the safety instrumented system 104 and connections between the channels. For example, the safety instrumented system 104 can have a one-out-of-one (1oo1) architecture with one channel. Following this example, the safety instrumented system 104 dangerously fails when the one channel dangerously fails. According to another example, the safety instrumented system 104 can have a one-out-of-two (1oo2) architecture. Pursuant to this example, the safety instrumented system 104 with the 1oo2 architecture includes two channels, and the safety instrumented system 104 dangerously fails when both of the two channels dangerously fail. According to yet another example, the safety instrumented system 104 can have a two-out-of-two (2oo2) architecture with two channels, where the safety instrumented system 104 dangerously fails when either of the two channels dangerously fails. While the 1oo1, 1oo2, and 2oo2 architectures are described above, it is contemplated that the safety instrumented system 104 having substantially any other architecture is intended to fall within the scope of the hereto appended claims.

By way of illustration, if the safety instrumented system 104 has a 1oo1 architecture, then the configuration component 112 can supply a 1oo1 fault tree to be utilized by the fault tree analysis component 114 for evaluating the PFD 102 of the safety instrumented system 104. Similarly, for any other architecture of the safety instrumented system 104, the configuration component 112 can supply a corresponding fault tree to be employed by the fault tree analysis component 114 for analyzing the PFD 102.

The factors 110 retained in the data store 108 can include mean time of repair (MTTR), refurbishment period, proof test interval, percentage of proof test coverage, dangerous detected failure rate, dangerous undetected failure rate, and/or beta. MTTR is an average period of time for repairing a failed component of the safety instrumented system 104. The refurbishment period is a period of time between two subsequent refurbishments. The refurbishment period, for example, can be on the order of years. A proof test interval is a period of time after which a proof test is performed to reveal dangerous undetected failures. For example, a proof test may be performed infrequently, and thus, a proof test interval can be on the order of months or years. The percentage of proof test coverage represents a percentage of dangerous undetected failures revealed by the proof test.

Moreover, a failure rate represents a magnitude of a relative number of failures during a given period of time. The dangerous detected failure rate corresponds to the magnitude of the relative number of dangerous detected failures identified through diagnostic testing during a given period of time. The dangerous undetected failure rate corresponds to the magnitude of the relative number of dangerous undetected failures that are not identified through diagnostic testing during a given period of time.

Further, beta represents a fraction of a total dangerous detected failure rate or total dangerous undetected failure rate per definition of a common cause failure rate. The fraction reflects a failure that is a result of one or more events that cause coincident failures of two or more separate channels in a multiple channel safety instrument system, which leads to system failure.

The data store 108 can retain respective values for the above-noted factors 110 for corresponding components, channels, or the like. For example, respective values of the factors 110 corresponding to a given component of the safety instrumented system 104 can be retained in the data store 108. Following this example, the failure evaluation component 106 can analyze the PFD 102 for such given component. According to another example, respective values of the factors 110 corresponding to a given channel of the safety instrumented system 104 can be retained in the data store 108, and thus, the failure evaluation component 106 can analyze the PFD 102 for that given channel. By way of yet another example, the failure evaluation component 106 can analyze the PFD 102 for a combination of components, a combination of channels, or the like.

Although many of the examples set forth herein describe the factors 110 being retained in and retrieved from the data store 108, it is contemplated that values of the factors 110 can additionally or alternatively be supplied via an input. For instance, the values of at least a subset of the factors 110 can be obtained by way of a user interface (e.g., from a user). Yet, the claimed subject matter is not limited to the foregoing example.

Based upon the architecture of the safety instrumented system 104, the configuration component 112 provides the fault tree. The fault tree analysis component 114 employs the provided fault tree to yield the PFD 102 for the safety instrumented system 104. Accordingly, the fault tree analysis component 114 enables the PFD 102 to be calculated using a fault tree approach. In contrast, conventional approaches for calculating a PFD oftentimes employ a Markov's analysis approach, and thus, such conventional approaches are typically complex. The conventional approaches can be compliant to IEC 61508 and 61511 standards; however, due to complexity of these conventional approaches, results yielded thereby can be difficult to verify and limited insight concerning impact of various factors upon the calculated PFD can be available. Accordingly, it can be difficult at best to optimize a safety instrumented system to satisfy IEC 61508 and 61511 standards when using such conventional approaches. Additionally, confidence in the results and understanding of respective affects of different factors on the PFD calculation can be lower with the conventional approaches compared to the system 100, which supports use of a fault tree approach. The system 100, by implementing a fault tree approach, allows for verification of the yielded PFD 102 via hand calculation. Hand calculation by deriving equations for the PFD 102 employed as part of the fault tree analysis implemented by the system 100 can provide increased confidence in the calculation and more insight into the results (e.g., respective contributions of various factors upon the yielded PFD 102).

Many of the examples set forth herein describe that the failure evaluation component 106 can evaluate the PFD 102 and assign a corresponding SIL for the safety instrumented system 104 (e.g., at a safety instrumented system level). However, it is contemplated that the safety instrumented system 104 can have several safety instrumented functions, and thus, the failure evaluation component 106 can evaluate PFDs and assign corresponding SILs for the safety instrumented functions included in the safety instrumented system 104 (e.g., at a safety instrumented function level).

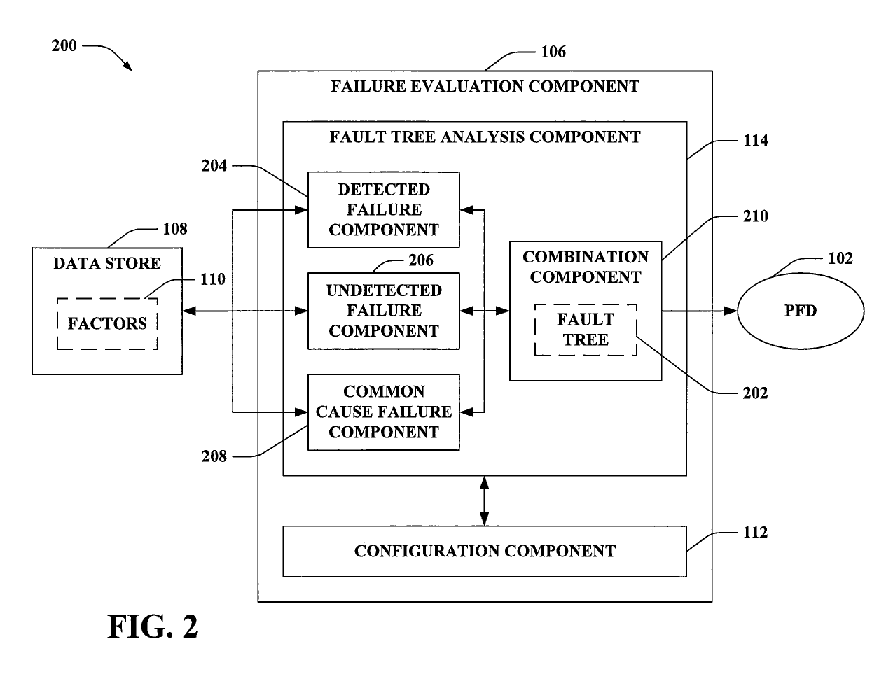

Turning to FIG. 2, illustrated is a system 200 that calculates a PFD 102. The system 200 can calculate the PFD 102 for a safety instrumented system, a channel of a safety instrumented system, a combination of channels of a safety instrumented system, a component of a safety instrumented system, a combination of components of a safety instrumented system, or the like. The system 200 includes the failure evaluation component 106 and the data store 108. The failure evaluation component 106 further includes the configuration component 112 and the fault tree analysis component 114. The configuration component 112 provides a fault tree 202 for evaluating the PFD 102 to the fault tree analysis component 114, and the fault tree analysis component 114 utilizes the fault tree 202 to calculate the PFD 102 based on factors 110 retained in the data store 108.

Moreover, the fault tree analysis component 114 can further include a detected failure component 204, an undetected failure component 206, a common cause failure component 208, and a combination component 210. The detected failure component 204 analyzes factors 110 related to dangerous detected failures. Further, the detected failure component 204 determines a failure probability due to dangerous detected failures. Moreover, the undetected failure component 206 analyzes factors 110 related to dangerous undetected failures, and determines a failure probability due to the dangerous undetected failures. Further, the common cause failure component 208 can evaluate factors 110 related to common cause failures, and can determine failure probabilities due to common cause dangerous detected failures and common cause dangerous undetected failures. It is to be appreciated that the common cause failure component 208 can be leveraged when the PFD 102 for more than one component, channel, etc. is being evaluated by the fault tree analysis component 114 (e.g., for architectures other than 1oo1).

The combination component 210 can join failure probabilities yielded by the detected failure component 204, the undetected failure component 206, and/or the common cause failure component 208 to calculate the PFD 102. The combination component 210 joins the failure probabilities according to the fault tree 202.

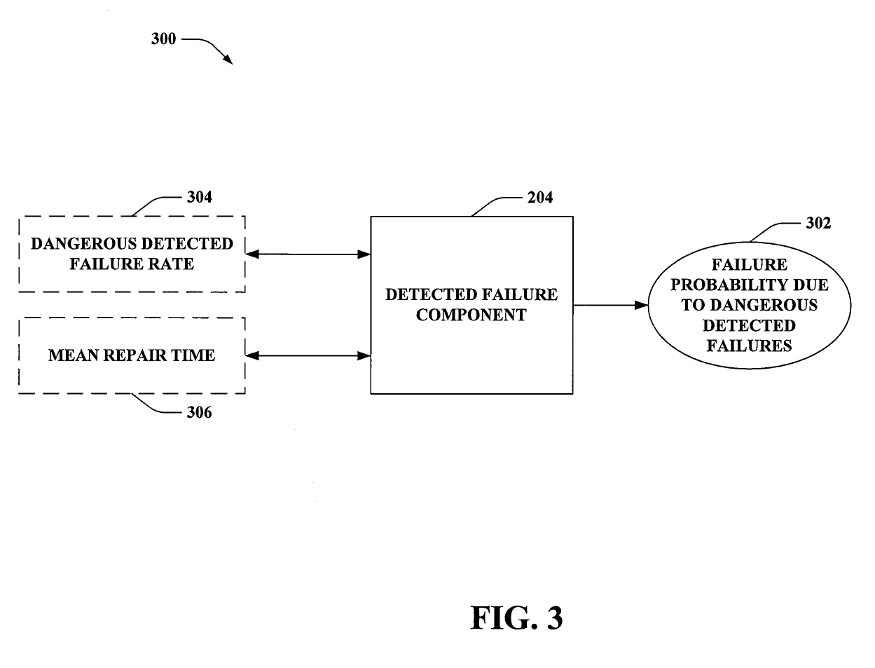

FIG. 3 illustrates an example system 300 that yields a failure probability due to dangerous detected failures 302. According to the depicted example, the detected failure component 204 can generate the failure probability due to dangerous detected failures 302 as a function of a dangerous detected failure rate 304 and a MTTR 306. Although not shown, it is to be appreciated that the dangerous detected failure rate 304 and the MTTR 306 can be factors 110 retained in the data store 108. By way of further illustration, although not depicted, the failure probability due to dangerous detected failures 302 yielded by the detected failure component 204 can be joined with one or more other failure probabilities by the combination component 210 according to the fault tree 202 to yield the PFD 102.

According to an example, the failure probability due to dangerous detected failures 302 can be evaluated by the detected failure component 204 for a single component, channel, or the like of a safety instrumented system by evaluating λ_{dd}RT, where λ_{dd} is the dangerous detected failure rate 304 and RT is the MTTR 306. It is to be appreciated, however, that the claimed subject matter is not limited to the foregoing example where the detected failure component 204 yields the failure probability due to dangerous detected failures 302 for a single component, channel, etc.

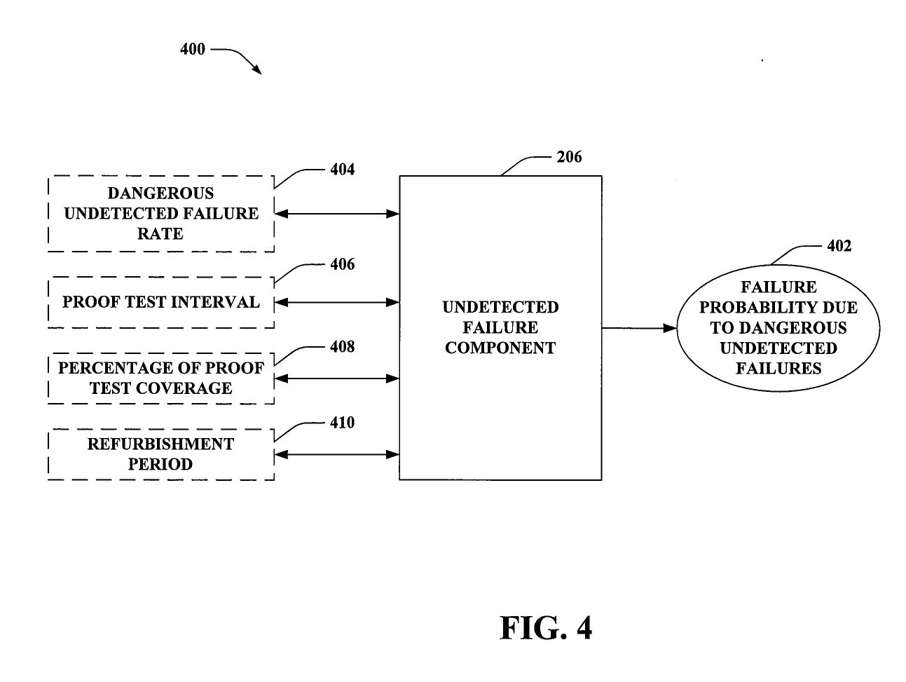

Now referring to FIG. 4, illustrated is an example system 400 that yields a failure probability due to dangerous undetected failures 402. As shown, the undetected failure component 206 can generate the failure probability due to dangerous undetected failures 402 as a function of a dangerous undetected failure rate 404, a proof test interval 406, a percentage of proof test coverage 408, and a refurbishment period 410. Although not depicted, it is contemplated that the dangerous undetected failure rate 404, the proof test interval 406, the percentage of proof test coverage 408, and the refurbishment period 410 can be factors 110 retained in the data store 108. By way of further illustration, although not shown, the failure probability due to dangerous undetected failures 402 yielded by the undetected failure component 206 can be joined with one or more other failure probabilities by the combination component 210 according to the fault tree 202 to yield the PFD 102.

Pursuant to an example, the failure probability due to dangerous undetected failures 402 can be analyzed by the undetected failure component 206 for a single component, channel, or the like of a safety instrumented system by evaluating

$$\frac{{Xλ}_{du} T}{2} + \frac{( 1 - X ) {λ}_{du} ( Re In )}{2} ,$$

where λ_{du} is the dangerous undetected failure rate 404, T is the proof test interval 406, X is the percentage of proof test coverage 408, and Re In is the refurbishment period 410. According, a proof test can be considered imperfect by the undetected failure component 206 (e.g., X less than 100%); hence, a part of the dangerous undetected failures can be detected during proof testing and the rest of the dangerous undetected failures can be detected during refurbishment. It is to be appreciated, however, that the claimed subject matter is not limited to the foregoing example where the undetected failure component 206 yields the failure probability due to dangerous undetected failures 402 for a single component, channel, etc.

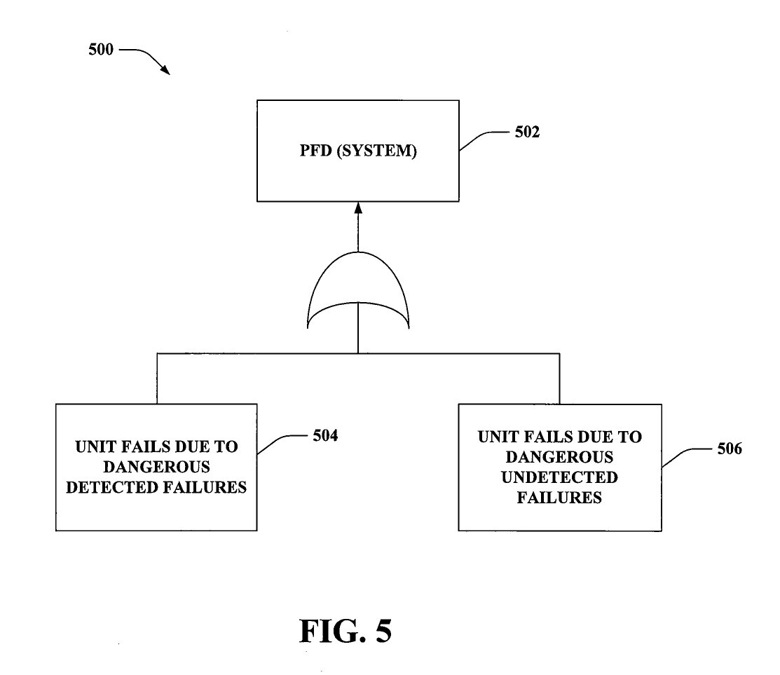

Turning to FIG. 5, illustrated is a fault tree 500 that can be utilized (e.g., by the combination component 210) when generating a PFD 502 for a 1oo1 architecture. The PFD 502 yielded with the fault tree 500 can be based on a single unit (e.g., single component of a safety instrumented system, single channel of a safety instrumented system, etc.). The logic implemented by the fault tree 500 is that the safety instrumented system fails if the unit dangerously fails.

The PFD 502 can be yielded by combining (e.g., effectuated by the combination component 210) a failure probability that the unit fails due to dangerous detected failures 504 and a failure probability that the unit fails due to dangerous undetected failures 506. For instance, the failure probability that the unit fails due to dangerous detected failures 504 can be yielded by the detected failure component 204 as a function of the dangerous detected failure rate 304 and the MTTR 306 for the unit as described in FIG. 3. Further; the failure probability that the unit fails due to dangerous undetected failures 506 can be yielded by the undetected failure component 206 as a function of the dangerous undetected failure rate 404, the proof test interval 406, the percentage of proof test coverage 408, and the refurbishment period 410 for the unit as set forth in FIG. 4.

The PFD 502 for the 1oo1 architecture can be obtained based upon the following. Moreover, the below expressions can assume constant failure rates (e.g., the dangerous detected failure rate 304 and the dangerous undetected failure rate 404) and constant repair time (e.g., the MTTR 306). Further, it can be assumed that diagnostic time can be much shorter than average repair time (e.g., the MTTR 306), and similarly average repair time (e.g., the MTTR 306) can be much shorter than the proof test interval 406. It is to be appreciated, however, that the claimed subject matter is not limited to the below example, which is provided for purposes of illustration.

Failure at a time of inspection, F(t), can be represented according to the below expression:

F(t)=1−exp(−λ_{dd}RT+λ_{du}t)

In this expression, λ_{dd} is a dangerous detected failure rate, λ_{du} is a dangerous undetected failure rate, RT is a repair time (e.g., MTTR), and t is an inspection time. Accordingly, the following expressions can result.

F(t)≈λ_{dd}RT+λ_{du}t

PFD(t)≈λ_{dd}RT+λ_{du}t

In the above expression, PFD(t) is the probability of failure on demand at an inspection time. Hence, an average probability of failure on demand, PFD(Avg), can be yielded pursuant to the below expressions.

$$PFD ( Avg ) = \frac{1}{t} {\int }_{0}^{t} PFD ( t ) d t$$

$$PFD ( Avg ) = \frac{1}{t} {\int }_{0}^{t} ( {λ}_{dd} RT + {λ}_{du} t ) d t$$

$$PFD ( Avg ) = {λ}_{dd} RT + \frac{{λ}_{du} t}{2}$$

Further, as noted above, a proof test can be considered imperfect (e.g., less than 100% of dangerous undetected failures can be revealed by the proof test). Moreover, the inspection time, t, in the above expression can be represented as the proof test interval, T. Thus, the average probability of failure on demand, PFD(Avg), for a 1oo1 architecture can be represented as follows.

$${PFD ( Avg )}_{1 oo 1} = {λ}_{dd} RT + \frac{{Xλ}_{du} T}{2} + \frac{( 1 - X ) {λ}_{du} ( ReIn )}{2}$$

In the foregoing equation, X is the percentage of proof test coverage and Re In is the refurbishment period.

Again, reference is made to FIG. 2. According to an example, for a 1oo1 architecture, the configuration component 112 can supply the fault tree 500 from FIG. 5 (e.g., the fault tree 202 is the fault tree 500 per this example). Pursuant to this example, the fault tree analysis component 114 can determine the PFD 102 using the fault tree 500. Hence, the fault tree analysis component 114 can calculate the PFD 102 by evaluating

$${PFD ( Avg )}_{1 oo 1} = {λ}_{dd} RT + \frac{X {λ}_{du} T}{2} + \frac{( 1 - X ) {λ}_{du} ( ReIn )}{2} .$$

Thus, the fault tree analysis component 114 can calculate the PFD 102 as a function of the dangerous detected failure rate (per hour), the dangerous undetected failure rate (per hour), the MTTR (in hours), the proof test interval (in hours), the refurbishment interval (in hours), and the percentage of proof test coverage. For instance, the detected failure component 204 can determine the failure probability due to dangerous detected failures by analyzing λ_{dd}RT, and the undetected failure component 206 can determine the failure probability due to dangerous undetected failures by analyzing

$$\frac{X {λ}_{du} T}{2} + \frac{( 1 - X ) {λ}_{du} ( ReIn )}{2} .$$

Moreover, the common cause failure component 208 need not be employed for a 1oo1 architecture. Further, based upon the logic supplied by the fault tree 500, the combination component 210 can add the failure probability due to dangerous detected failures yielded by the detected failure component 204 with the failure probability due to dangerous undetected failures yielded by the undetected failure component 206 to generate the PFD 102.

Respective impact corresponding to the factors upon the calculated PFD 102 can be ascertained. Moreover, results for the PFD 102 yielded by the failure evaluation component 106 when the fault tree 500 is utilized for the 1oo1 architecture can be validated. For instance, dangerous detected failure rate, dangerous undetected failure rate, and refurbishment period can be constants, while diagnostic test coverage (DTC), diagnostic test interval (DTI), percentage of proof test coverage, and proof test interval can be varied. Varying the DTC can affect the dangerous detected failure rate and the dangerous undetected failure rate. For instance, the results for the PFD 102 outputted by the failure evaluation component 106 based upon the fault tree 500 can be compared to results yielded from conventional approaches; however, it is to be appreciated that the claimed subject matter is not so limited.

Moreover, it is to be appreciated that the fault tree analysis component 114 can determine the PFD 102 for a higher level architecture (e.g., 1oo2, 2oo2, 2oo3, etc.) in a similar manner as compared to the 1oo1 architecture. For a higher level architecture, the common cause failure component 208 can determine failure probabilities due to common cause dangerous detected failures and common cause dangerous undetected failures.

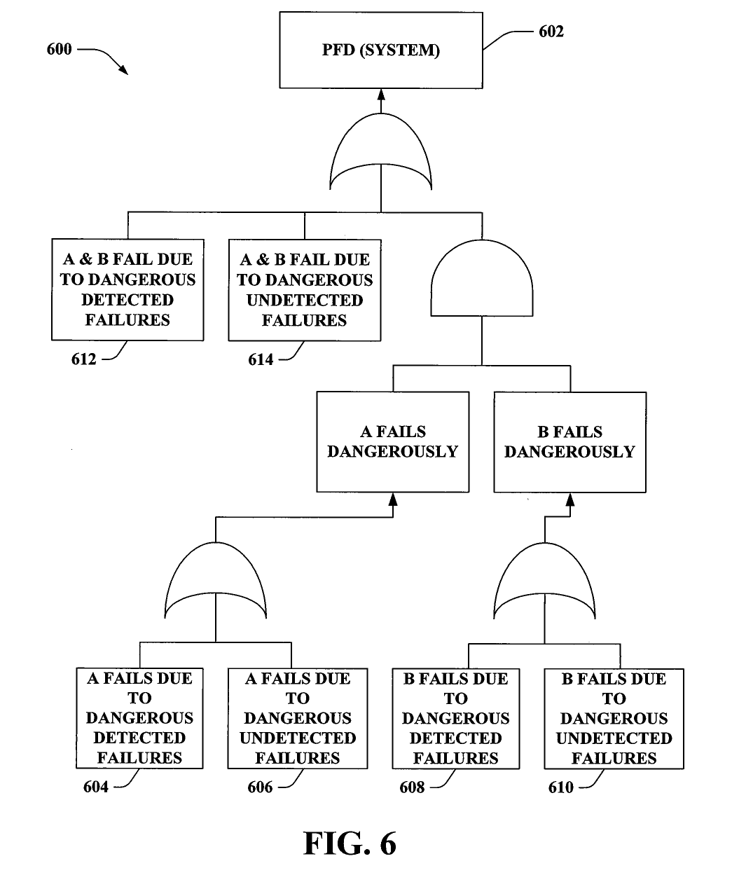

Now referring to FIG. 6, illustrated is a fault tree 600 that can be utilized (e.g., by the combination component 210) when generating a PFD 602 for a 1oo2 architecture. The PFD 602 generated with the fault tree 600 can be based on two units, unit A and unit B (e.g., two components of a safety instrumented system, two channels of a safety instrumented system, etc.). The logic implemented by the fault tree 600 is that the safety instrumented system fails if both of the units A and B dangerously fail.

The PFD 602 can be yielded by combining (e.g., effectuated by the combination component 210) a failure probability that unit A fails due to dangerous detected failures 604, a failure probability that unit A fails due to dangerous undetected failures 606, a failure probability that unit B fails due to dangerous detected failures 608, a failure probability that unit B fails due to dangerous undetected failures 610, a failure probability that units A and B fail due to common cause dangerous detected failures 612, and a failure probability that units A and B fail due to common cause dangerous undetected failures 614. Thus, pursuant to the depicted example of FIG. 6, the fault tree 600 can have common cause blocks apart from the dangerous detected failures for unit A and unit B and the dangerous undetected failures for unit A and unit B.

The failure probability that unit A fails due to dangerous detected failures 604 and the failure probability that unit B fails due to dangerous detected failures 608 can be yielded by the detected failure component 204. Moreover, the failure probability that unit A fails due to dangerous undetected failures 606 and the failure probability that unit B fails due to dangerous undetected failures 610 can be yielded by the undetected failure component 206. Further, the failure probability that units A and B fail due to common cause dangerous detected failures 612 and the failure probability that units A and B fail due to common cause dangerous undetected failures 614 can be yielded by the common cause failure component 208. The combination component 210 can combine the foregoing failure probabilities 604-614 based upon the fault tree 600 to determine the PFD 602 of the safety instrumented system.

Employing a similar approach as used for the 1oo1 architecture above, the following expression for the average probability of failure on demand, PFD(Avg), for a 1oo2 architecture can result. Moreover, this expression can be utilized by the fault tree analysis component 114 to generate the PFD 102.

$${PFD ( Avg )}_{1 oo 2} = {λ}_{ddc} RT + 0.5 {Xλ}_{duc} T + 0.5 ( 1 - X ) {λ}_{duc} ( ReIn ) + {( {λ}_{ddn} RT )}^{2} + 0.34 {( {Xλ}_{dun} T )}^{2} + 0.34 {( ( 1 - X ) {λ}_{dun} ( ReIn ) )}^{2} + {Xλ}_{ddn} {RTλ}_{dun} T + ( 1 - X ) {λ}_{ddn} {RTλ}_{dun} ( ReIn )$$

In the foregoing expression, λ_{ddc} is a common cause dangerous detected failure rate, λ_{duc} is a common cause dangerous undetected failure rate, λ_{ddn} is a dangerous detected failure rate, and λ_{dun} is a dangerous undetected failure rate. According to the above equation leveraged for the 1oo2 architecture, common cause failure mode factors can be considered by the fault tree analysis component 114. Hence, failure of components in a channel due to a common cause, which can be categorized as dangerous detected common cause or dangerous undetected common cause, can be evaluated when calculating a PFD. Moreover, the common cause dangerous detected failure rate and the common cause dangerous undetected failure rate can be percentages of a total dangerous detected failure rate and a total dangerous undetected failure rate, respectively, as set forth in a beta model.

For instance, total dangerous failure rates that include common cause dangerous failure rates can be described by the following expressions.

λ_{duT}=λ_{duA}+λ_{duc}

λ_{ddT}=λ_{ddA}+λ_{ddc}

In the foregoing expressions, λ_{duT} is a total dangerous undetected failure rate, λ_{duA} is a reported dangerous undetected failure rate from different databases, and λ_{duc} is a common cause dangerous undetected failure rate. Moreover, λ_{ddT} is a total dangerous detected failure rate, λ_{ddA} is a reported dangerous detected failure rate from different databases, and λ_{ddc} is a common cause dangerous detected failure rate.

As per the definition of common cause failure rate, beta is a fraction of the total dangerous detected failure rate or the total dangerous undetected failure rate. The fraction can reflect failures which are the result of one or more events the cause coincident failure of two or more separate channels in a multiple channel system, which leads to system failure. According to an example, beta can vary from 2-5% depending on technology and location; however, it is to be appreciated that the claimed subject matter is not so limited.

The following expressions are based on the foregoing description of beta.

λ_{duc}=β₁λ_{duT}

λ_{ddc}=β₂λ_{ddT}

Moreover, as λ_{duT}>>λ_{duc} and λ_{ddT}>>λ_{ddc}, it follows that λ_{duT}≈λ_{duA} and λ_{ddT}≈λ_{ddA}. Thus, λ_{duA} and λ_{ddA} can be conservative failure rates as these are almost equal to total failure rates of blocks, yet not reduced by common cause failure rates of the blocks.

Further, it can be assumed that β₁=β₂=β. Based upon such assumption, the following expressions can be yielded.

λ_{duc}=βλ_{duT}

λ_{ddc}=βλ_{ddT}

According to an example, the total dangerous undetected failure rate, λ_{duT}, and the total dangerous detected failure rate, λ_{ddT}, can be available (e.g., retained factors 110 in the data store 108). Following this example, the reported dangerous undetected failure rate from different databases, λ_{duA}, the common cause dangerous undetected failure rate, λ_{duc}, the reported dangerous detected failure rate from different databases, λ_{ddA}, and the common cause dangerous detected failure rate, λ_{ddc}, can be determined pursuant to the following expressions.

λ_{duc}=βλ_{duT}

λ_{ddc}=βλ_{ddT}

λ_{duA}=(1−β)λ_{duT}

λ_{ddA}=(1−β)λ_{ddT}

By way of example, if values for the total dangerous undetected failure rate, the total dangerous detected failure rate, and beta are inputted to the fault tree analysis component 114, βλ_{duT} can replace λ_{duc} and βλ_{ddT} can replace λ_{ddc} in the expression set forth above for determining the average probability of failure on demand, PFD(Avg), for the loot architecture. Following this example, according to an illustration, the total dangerous undetected failure rate, λ_{duT} can be used as the dangerous undetected failure rate, λ_{dun}, and the total dangerous detected failure rate, λ_{ddT}, can be used as the dangerous detected failure rate, λ_{ddn}, in the expression for determining the average probability of failure on demand for the 1oo2 architecture. According to another illustration, (1−β)λ_{duT} can replace λ_{dun} and (1−β)λ_{ddT} can replace λ_{ddn} in the expression for determining the average probability of failure on demand for the 1oo2 architecture. However, it is to be appreciated that the claimed subject matter is not so limited.

It is to be appreciated that the example fault trees described in FIGS. 5-6 are provided for illustration purposes. Moreover, it is contemplated that the claimed subject matter is not limited to the example fault trees set forth in FIGS. 5-6. For example, architectures other than 1oo1 and 1oo2 are intended to fall within the scope of the hereto appended claims.

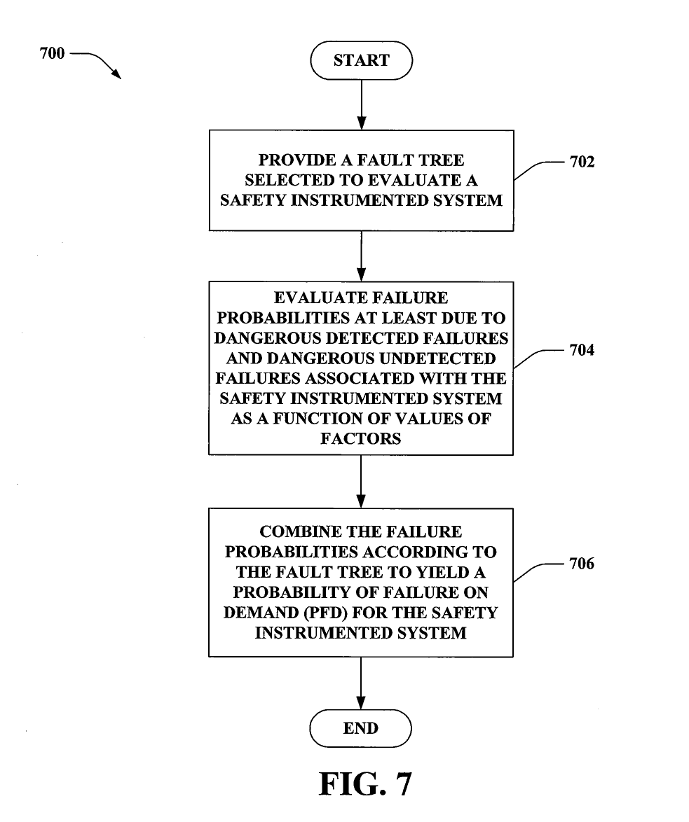

FIG. 7 illustrates a methodology relating to determining a PFD using a fault tree approach. While, for purposes of simplicity of explanation, the methodology is shown and described as a series of acts, it is to be understood and appreciated that the methodology is not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, a subset of the illustrated acts may not be required to implement a methodology in accordance with one or more embodiments.

FIG. 7 illustrates a methodology 700 that facilitates determining a probability of failure on demand (PFD) for a safety instrumented system. At 702, a fault tree selected to evaluate the safety instrumented system can be provided. For example, the fault tree can be selected as a function of an architecture of the safety instrumented system or a portion thereof. According to another example, the fault tree can be selected based upon a received input (e.g., user input, etc.).

At 704, failure probabilities at least due to dangerous detected failures and dangerous undetected failures associated with the safety instrumented system can be evaluated as a function of values of factors. According to an example, the factors can include one or more of a mean time of repair (MTTR), a refurbishment period, a proof test interval, a percentage of proof test coverage, a dangerous detected failure rate, a dangerous undetected failure rate, or a beta. For instance, the values of the factors can be retrieved from a data store; however, it is contemplated that the values of the factors can be obtained from substantially any other source (e.g., user input, etc.). Moreover, the factors utilized to evaluate the failure probabilities can be a function of the fault tree.

According to an example, a failure probability due to dangerous detected failures can be evaluated as a function of a dangerous detected failure rate and a MTTR. By way of another example, a failure probability due to dangerous undetected failures can be evaluated as a function of a dangerous undetected failure rate, a proof test interval, a percentage of proof test coverage, and a refurbishment period. Following this example, a portion of the dangerous undetected failures can be detected during proof testing and a remainder of the dangerous undetected failures can be detected during refurbishment. Thus, a portion of the failure probability due to dangerous undetected failures can be based on failures detected during proof testing and a remainder of the failure probability due to dangerous undetected failures can be based on failures detected during refurbishment.

By way of a further example, a plurality of failure probabilities due to dangerous detected failures and a plurality of failure probabilities due to dangerous undetected failures can be evaluated. The plurality of failure probabilities due to dangerous detected failures and the plurality of failure probabilities due to dangerous undetected failures can be respectively evaluated for disparate components, channels, etc. of the safety instrumented system (e.g., when the PFD for more than one component, channel, etc. of the safety instrumented system is analyzed).

Pursuant to another example, a failure probability due to common cause dangerous detected failures and a failure probability due to common cause dangerous undetected failures can be evaluated as a function of the values of the factors. Following this example, common cause failures can be categorized as common cause dangerous detected failures or common cause dangerous undetected failures. For instance, the failure probability due to common cause dangerous detected failures and the failure probability due to the common cause dangerous undetected failures can be determined as a function of a value of beta. Beta represents a fraction of a total dangerous detected failure rate or a total dangerous undetected failure rate reflective of a failure that is a result of one or more events that cause coincident failures of two or more separate components, channels, etc. of the safety instrumented system.

At 706, the failure probabilities can be combined according to the fault tree to yield the PFD for the safety instrumented system. For example, if the fault tree has a 1oo1 architecture, then the failure probability due to dangerous detected failures and the failure probability due to dangerous undetected failures can be summed. However, the claimed subject matter is not limited to the foregoing example as it is contemplated that the failure probabilities can be combined in different manners depending on an architecture of the fault tree.

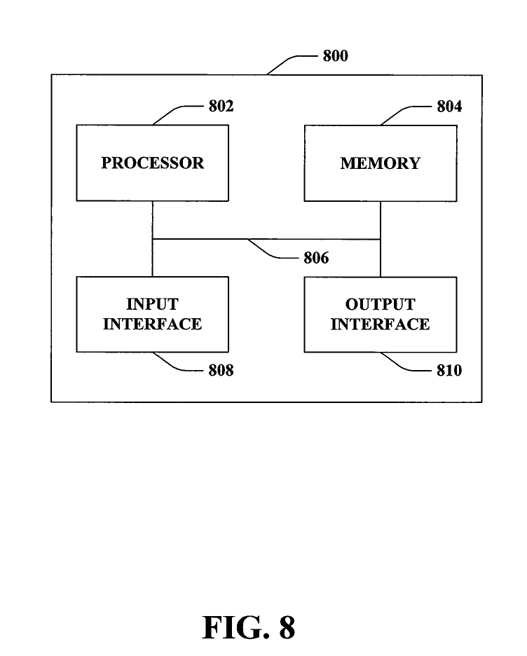

Referring now to FIG. 8, a high-level illustration of an example computing device 800 that can be used in accordance with the systems and methodologies disclosed herein is illustrated. For instance, the computing device 800 may be used in a system that generates a PFD for a safety instrumented system based upon a fault tree. In another example, the computing device 800 can be used to provide a fault tree that can be leveraged for calculating a PFD of a safety instrumented system. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store values of the factors described herein.

The computing device 800 also includes an input interface 808 that allows external devices to communicate with the computing device 800. For instance, the input interface 808 may be used to receive instructions from an external computer device, from a user, etc. The computing device 800 also includes an output interface 810 that interfaces the computing device 800 with one or more external devices. For example, the computing device 800 may display text, images, etc. by way of the output interface 810.

Additionally, while illustrated as a single system, it is to be understood that the computing device 800 may be a distributed system. Thus, for instance, several devices may be in communication by way of a network connection and may collectively perform tasks described as being performed by the computing device 800.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of medium. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Combinations of the above should also be included within the scope of computer-readable media.

At least one technical effect of the present invention is that critical safety loops within a power generating plant respond appropriately when they are required to act during an emergency event.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims.

What is claimed is:

1. A computer-readable medium including computer-executable instructions that, when executed by a processor, cause the processor to perform acts including:
selecting a fault tree based upon an architecture of a safety instrumented system;
evaluating at least a failure probability due to dangerous detected failures and a failure probability due to dangerous undetected failures associated with the safety instrumented system as a function of values of factors, wherein a portion of the failure probability due to dangerous undetected failures is based on failures detected during proof testing and a remainder of the failure probability due to dangerous undetected failures is based on failures detected during refurbishment; and
generating a probability of failure on demand (PFD) for the safety instrumented system by combining at least the failure probability due to dangerous detected failures and the failure probability due to dangerous undetected failures according to the fault tree.

2. The computer-readable medium of claim 1 further including computer-executable instructions that, when executed by the processor, cause the processor to perform acts including:
determining a failure probability due to common cause dangerous detected failures and a failure probability due to common cause dangerous undetected failures as a function of a value of a beta; and
generating the PFD for the safety instrumented system by combining at least the failure probability due to common cause dangerous detected failures, the failure probability due to common cause dangerous detected failures, the failure probability due to dangerous detected failures, and the failure probability due to dangerous undetected failures according to the fault tree.

3. The computer-readable medium of claim 2, wherein the beta represents a fraction of a total dangerous detected failure rate or a total dangerous undetected failure rate reflective of a failure that is a result of one or more events that cause at least one of coincident failures of two or more separate components of the safety instrumented system or coincident failures of two or more separate channels of the safety instrumented system.

4. The computer-readable medium of claim 1, wherein the factors include one or more of a mean time of repair (MTTR), a refurbishment period, a proof test interval, a percentage of proof test coverage, a dangerous detected failure rate, a dangerous undetected failure rate, or a beta.

5. The computer-readable medium of claim 1, further including computer-executable instructions that, when executed by the processor, cause the processor to perform acts including:
evaluating the failure probability due to dangerous detected failures as a function of a dangerous detected failure rate and a mean time of repair (MTTR).

6. The computer-readable medium of claim 1, further including computer-executable instructions that, when executed by the processor, cause the processor to perform acts including:
evaluating the failure probability due to dangerous undetected failures as a function of a dangerous undetected failure rate, a proof test interval, a percentage of proof test coverage, and a refurbishment period.

7. A method that facilitates determining a probability of failure on demand (PFD) for a safety instrumented system configured for execution on a processor of a computing device, including:
providing a fault tree selected to evaluate the safety instrumented system;
evaluating failure probabilities at least due to dangerous detected failures and dangerous undetected failures associated with the safety instrumented system as a function of values of factors; and
combining the failure probabilities according to the fault tree to yield the PFD for the safety instrumented system.

8. The method of claim 7, further including selecting the fault tree as a function of an architecture of the safety instrumented system.

9. The method of claim 7, further including selecting the fault tree based upon a received input.

10. The method of claim 7, wherein the factors include one or more of a mean time of repair (MTTR), a refurbishment period, a proof test interval, a percentage of proof test coverage, a dangerous detected failure rate, a dangerous undetected failure rate, or a beta.

11. The method of claim 7, further including retrieving the values of the factors from a data store.

12. The method of claim 7, wherein the factors utilized to evaluate the failure probabilities are a function of the fault tree.

13. The method of claim 7, wherein the failure probabilities include a failure probability due to dangerous detected failures, wherein the failure probability due to dangerous detected failures is evaluated as a function of a dangerous detected failure rate and a mean time of repair (MTTR).

14. The method of claim 7, wherein the failure probabilities include a failure probability due to dangerous undetected failures, wherein the failure probability due to dangerous undetected failures is evaluated as a function of a dangerous undetected failure rate, a proof test interval, a percentage of proof test coverage, and a refurbishment period.

15. The method of claim 14, wherein a portion of the failure probability due to dangerous undetected failures is based on failures detected during proof testing and a remainder of the failure probability due to dangerous undetected failures is based on failures detected during refurbishment.

16. The method of claim 7, wherein the failure probabilities include a plurality of failure probabilities due to dangerous detected failures and a plurality of failure probabilities due to dangerous undetected failures.

17. The method of claim 7, wherein the failure probabilities include a failure probability due to common cause dangerous detected failures and a failure probability due to common cause dangerous undetected failures.

18. The method of claim 17, further including determining the failure probability due to common cause dangerous detected failures and the failure probability due to common cause dangerous undetected failures as a function of a value of a beta.

19. The method of claim 18, wherein the beta represents a fraction of a total dangerous detected failure rate or a total dangerous undetected failure rate reflective of a failure that is a result of one or more events that cause at least one of coincident failures of two or more separate components of the safety instrumented system or coincident failures of two or more separate channels of the safety instrumented system.

20. The method of claim 7, wherein the failure probabilities are summed when the fault tree has a 1oo1 architecture.
